(19) United States
(12) Patent Application Publication
(10) Pub. No.: US 2025/0307687 A1
(43) Pub. Date: Oct. 2, 2025

(54) REDUCING COMPUTATION COMPLEXITY AND INCREASING POWER EFFICIENCY IN MULTI-VARIANT INFERENCE MODELS

(71) Applicant: DELL PRODUCTS L.P., Round Rock, TX (US)

(72) Inventors: Farzad Khosrowpour, Pflugerville, TX (US); Nikhil Vichare, Austin, TX (US)

(21) Appl. No.: 18/616,906

(22) Filed: Mar. 26, 2024

(51) Int. Cl. G06N 20/00

(52) U.S. Cl. CPC G06N 20/00

(57) ABSTRACT

An information handling system may define a first grouping of inputs to a first inference model, determine a first number of inference stages for the first inference model, and calculate an accuracy of an output of the first inference model. When the accuracy is within a threshold accuracy, the system may load the first inference model to multiple computing devices.

### FIELD OF THE DISCLOSURE

This disclosure generally relates to information handling systems, and more particularly relates to reducing computation complexity and increasing power efficiency in multi-variant inference models in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may define a first grouping of inputs to a first inference model, determine a first number of inference stages for the first inference model, and calculate an accuracy of an output of the first inference model. When the accuracy is within a threshold accuracy, the system may load the first inference model to multiple computing devices.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system as may be known in the art;

FIG. 2 is a block diagram illustrating an information handling system according to an embodiment of the present disclosure;

FIG. 3 is a block diagram illustrating the information handling system of FIG. 2 in greater detail;

FIG. 4 is a flowchart illustrating the operation of an inference modeler of FIG. 2;

FIG. 5 is a flowchart illustrating a method for building an inference model for peak power efficiency according to an embodiment of the current disclosure; and

FIG. 6 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

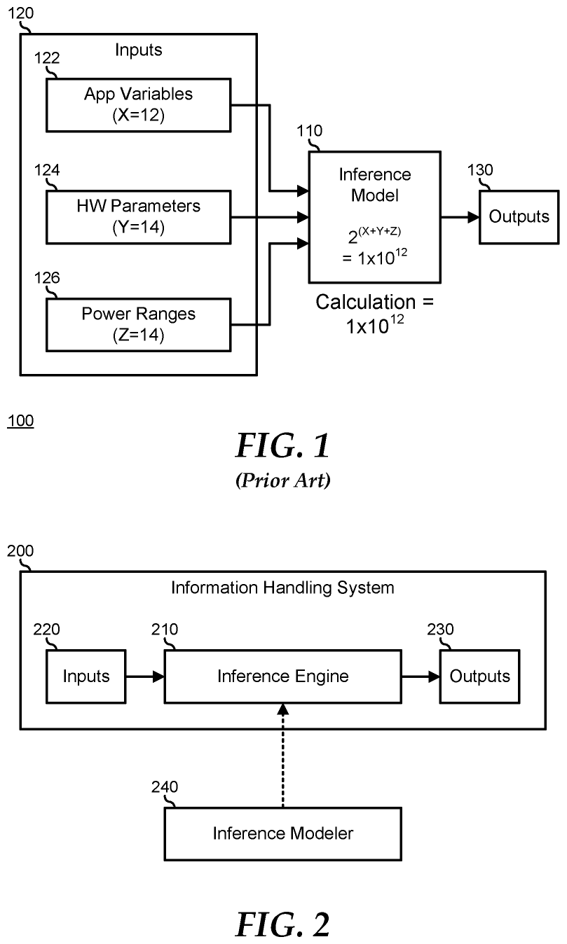

FIG. 1 illustrates an information handling system 100 as may be known in the art. Information handling system 100 is depicted as including an inference model 110 configured to receive inputs 120 and to apply an artificial intelligence/machine learning (AI/ML) model to the inputs to provide one or more outputs 130. As such, information handling system 100 may be understood to represent an individual computer system, a network of computer systems, a data center, or another level of computing elements as needed or desired. In particular, inference model 110 is configured to receive inputs 120, and to run the inputs through various AI/ML models to determine an optimized set of outputs 130. Inference model 110 may be configured to model inputs 120 based upon one or more policies, such as a low-power policy, a high-performance policy, a low-latency policy, a service-level-agreement (SLA) policy, or the like.

In this regard, outputs 130 will be understood to represent a state of each of the individual outputs that best satisfies the particular policy. For example, where a low-power policy is the aim of inference model 110, then the AI/ML model will be trained to minimize the power expenditure of information handling system 100, and will then provide a set of outputs 130 that provides the lowest power operation for the information handling system based upon the state of inputs 120. An example of an AI/ML model provided by inference engine 110 may include a regression model, a decision tree model, a support vector means model, a Naïve Bayes model, a K-nearest neighbors model, a K-means model, a random forest model, a dimensional reduction model, a gradient boosting model, or another type of AI/ML model, as needed or desired.

Inputs 120 are illustrated as including exemplary application variables 122, hardware parameters 124, and power ranges 126. In the illustrated example, application variables 122 include a number “X”=12 separate application variables, such as application utilization variables, application knob priority variables, application resource variables, of the like. Hardware parameters 124 include a number “Y”=14 separate hardware parameters, such as power levels, fan speeds, user selectable thermal tables, running average power limits, hardware utilization values, or the like. Power ranges 126 include a number “Z”=14 separate power ranges, such as running average power ranges, fan speed ranges, or the like. Inference model 110 may need a number of calculations “C” from inputs 120 that is equal to or greater than:

C=2^{(X+Y+Z)}=2⁴⁰=1×10¹² Equation 1.

It has been understood by the inventors of the current disclosure that the large number “C” of calculations needed to model outputs 130 may result in a large power usage and processing resource usage by information handling system 100. It has been further understood that a particular manufacturer may typically employ a particular inference model, such as inference model 110 across multiple information handling systems. For example, the manufacturer may ship millions of similar information handling systems with a particular inference model. As such, even a moderate improvement in power usage by a single information handling system that utilizes the particular inference model may provide an out-sized benefit to the overall power usage across all of the manufacturer's systems. The inventors of the current disclosure have estimated that a 10-15% improvement in processing efficiency for inference models in an estimated 25 million units shipped may result in a savings of greater than 500 tons of CO2 emitted by the systems.

FIG. 2 illustrates an information handling system 200 similar to information handling system 100. In particular, information handling system 200 is depicted as including an inference engine 210 configured to receive inputs 220 and to apply an AI/ML model to the inputs to provide one or more outputs 230. Information handling system 200 may thus be understood to represent an individual computer system, a network of computer systems, a data center, or another level of computing elements as needed or desired. Further, inference engine 210 is configured to receive inputs 220, and to run the inputs through various AI/ML models to determine an optimized set of outputs 230. Inference engine 210 may be configured to model inputs 220 based upon one or more policies, such as a low-power policy, a high-performance policy, a low-latency policy, a SLA policy, or the like.

Outputs 230 represent a state of each of the individual outputs that best satisfies the particular policy. For example where a low-power policy is the aim of inference engine 210, then the AI/ML model will be trained to minimize the power expenditure of information handling system 200, and will then provide a set of outputs 230 that provides the lowest power operation for the information handling system based upon the state of inputs 220. An example of an AI/ML model provided by inference engine 210 may include a regression model, a decision tree model, a support vector means model, a Naïve Bayes model, a K-nearest neighbors model, a K-means model, a random forest model, a dimensional reduction model, a gradient boosting model, or another type of AI/ML model, as needed or desired.

Inference engine 220 differs from inference model 120 in that the AI/ML models utilized by the inference engine are optimized to provide multiple inference stages (that is, separate inference models), where each inference stage operates on a small subset of inputs 220 to simplify the modeling provided by each stage. The inference stages of inference engine 210 are provided based upon an evaluation of the inference process provided by an inference modeler 240. In particular, inference modeler 240 operates to evaluate inputs 220 and to methodically refine the inference models utilized, and the number and characteristics of the inputs to provide an optimized set of inference stages. Thus inference modeler 240 operates out of band from information handling system 200 to perform the evaluations.

For example, a manufacturer of information handling system 200 may operate inference modeler 240 to optimize the inference stages for a family of information handling systems as an activity provided during a development stage of the information handling systems, and can apply the optimized inference stages (that is, inference engine 220) to all of the information handling systems manufactured by the manufacturer. In another example, inference modeler 240 operates in parallel with the operation of information handling system 200. Each one of information handling system 200 that includes inference engine 210 operates to provide inference information from the activities of the inference engine back to inference modeler 240, and the inference modeler operates to refine the inference stages, and reloads the refined inference stages to the inference engine to the information handling systems 100 manufactured by the manufacturer.

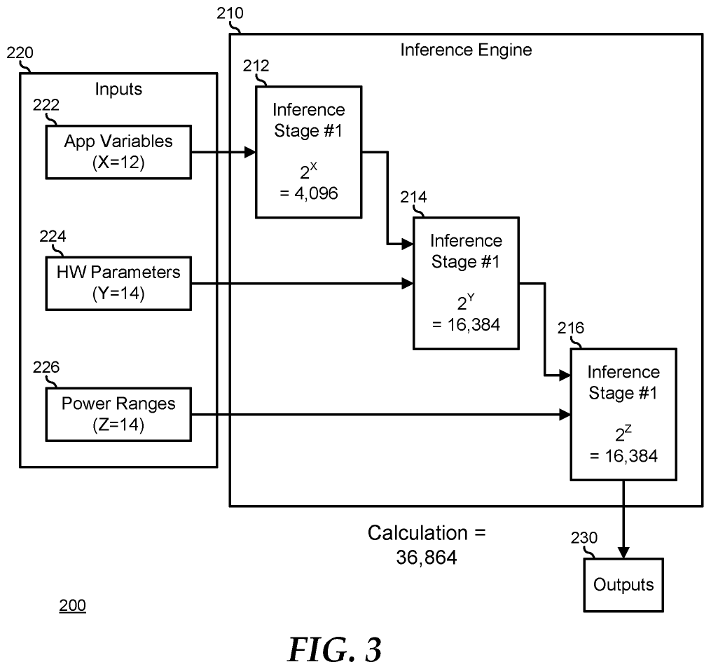

FIG. 3 illustrates information handling system 200 where inference engine 210 is illustrated as including first, second, and third inference stages 212, 214, and 216, and inputs 220 are illustrated as including exemplary application variables 222, hardware parameters 224, and power ranges 226. In the illustrated example, application variables 222 include a number “X”=12 separate application variables, such as application utilization variables, application knob priority variables, application resource variables, of the like. Hardware parameters 224 include a number “Y”=14 separate hardware parameters, such as power levels, fan speeds, user selectable thermal tables, running average power limits, hardware utilization values, or the like. Power ranges 226 include a number “Z”=14 separate power ranges, such as running average power ranges, fan speed ranges, or the like. Application variables 222 are processed in first inference stage 212. The output of first inference stage 212 and hardware parameters 224 are processed in second inference stage 214. The output of second inference stage and power ranges 226 are processed in third inference stage 216 which provides outputs 230. Inference engine 210 may need a number of calculations “C” from inputs 220 that is equal to or greater than:

C=2^{X}+2^{Y}+2^{Z}=2¹²+2¹⁴+2¹⁴=36,864 Equation 2.

Thus it can be seen that the number of calculations needed to generate outputs 230 by inference engine 210 is greatly reduced over the number of calculations by inference model 110 to generate similar outputs 130.

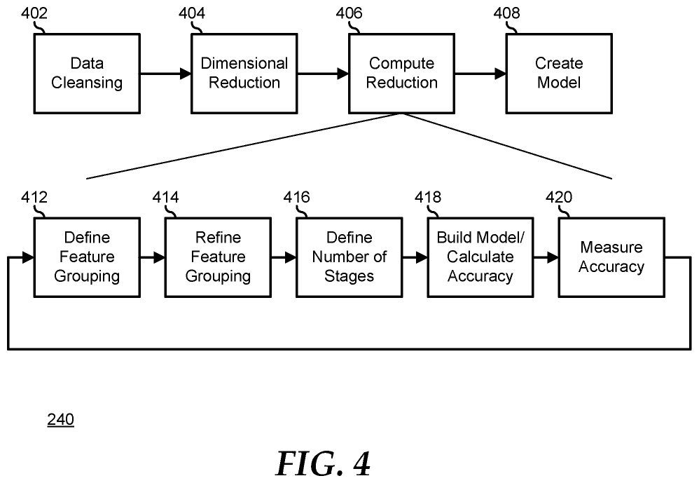

FIG. 4 illustrates inference modeler 240, including a data cleansing stage 402, a dimensional reduction stage 404, a compute reduction stage 406, and a model creation stage 408. Data cleansing stage 402 performs a process to fix or remove incorrect, corrupted, incorrectly formatted, duplicate, or incomplete data in the inputs to be considered. Dimensional reduction stage 404 operates to reduce the number of input variables or features in the dataset to simplify the data, eliminate redundant or irrelevant information, and improve the efficiency and accuracy of the AI/ML models. As such, dimensional reduction stage 404 may utilize various feature extraction techniques, such as peripheral component analysis (PCA), or feature reduction techniques, such as correlation analysis, recursive feature elimination (RFE), variable importance analysis, or the like.

In the typical generation of inference models, data cleansing and dimensional reduction are provided to a model creator that generates the AI/ML model for an inference engine. However in the current embodiments, compute reduction stage 406 is provided to create sub cluster grouping of the input features that have a high probability of being combined to allow creating multistage inferences instead of a single stage model. The activities of compute reduction stage 406 are expanded and show a recursive method including steps 412, 414, 416, 418, and 420. In a first step 412, the inputs are defined as feature set groupings. This step may utilize the evaluation of the inputs to the model to determine reasonably related inputs, such as the application variable inputs, the hardware parameter inputs, and the power range inputs, as described above. The feature set groupings are refined in the second step 414. In particular, the feature set groupings can be subject to various statistical or observational analyses, including Bayesian analysis, conditional analysis, absolute probability, contingency grouping, and the like.

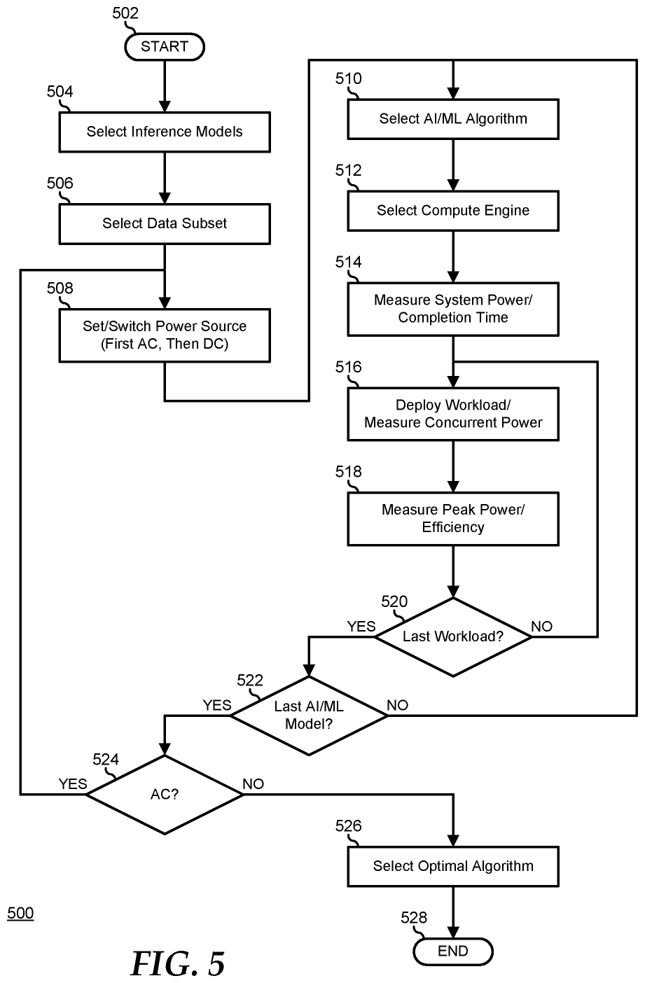

The output of step 414, that is, the input groupings, may define, in step 416, the number of inference stages. For example where the method steps 412 and 414 generate the input groupings as illustrated above, step 416 may determine that three (3) model stages are to be utilized in the inference engine. The number of stages may typically be two (2) or three (3) stages, but more stages may be defined, as needed or desired. In step 418, the inference model is built and the accuracy of the inference model is calculated. A detailed method for building an inference model is described with respect to FIG. 5, below. In step 420, the accuracy of the inference model is measured against a desired accuracy level. If the accuracy is within the desired accuracy level, the method ends and the inference model is provided to the information handling systems. If the accuracy is not within the desired accuracy level, the method returns to step 412.

FIG. 5 illustrates a method 500 for building an inference model for peak power efficiency operation of an information handling system, starting at block 502. The inference models for an inference engine are selected in block 504. For example, the inference models may be selected based upon the method as described with reference to FIG. 4 above. A subset of data is selected for modeling the inference models in block 506. A version of the information handling system is set to operate from an AC power source in block 508. The version of the information handling system may be a real-world information handling system, or a model of the information handling system, as needed or desired. A first one of the inference models is selected in block 510. A compute engine is selected in block 512. For example, the inference model may be selected to be operated on a central processing unit (CPU), a graphics processing unit (GPU), or another type of compute engine, as needed or desired. The selected inference model is launched on the selected compute engine, and the system power consumption and inference model completion time are measured in block 514.

A workload is deployed on the information handling system and the power consumption is measured in block 516. The power consumption and peak power consumption for the information handling system is measured and the efficiency is calculated in block 518. A decision is made as to whether or not all concurrent workloads have been deployed in decision block 520. If not, the “NO” branch of decision block 520 is taken and the method returns to block 516, where a next workload is deployed. When all current workloads have been deployed, the “YES” branch of decision block 520 is taken, and a decision is made as to whether or not the last inference model has been selected in decision block 522. If not, the “NO” branch of decision block 522 is taken and the method returns to block 510, where a next inference model is selected. When the last inference model has been selected, the “YES” branch of decision block 522 is taken, and a decision is made as to whether the information handling system is being powered by the AC power source in decision block 524. If so, the “YES” branch of decision block 524 is taken and the method returns to block 508, where the information handling system is set to operate from a DC power source. When the information handling system is not being powered by the AC power source (that is, when the information handling system is being powered by the DC power source), the “NO” branch of decision block 524 is taken, the results of the method are tabulated and the optimal algorithm is selected in block 526, and the method ends in block 528.

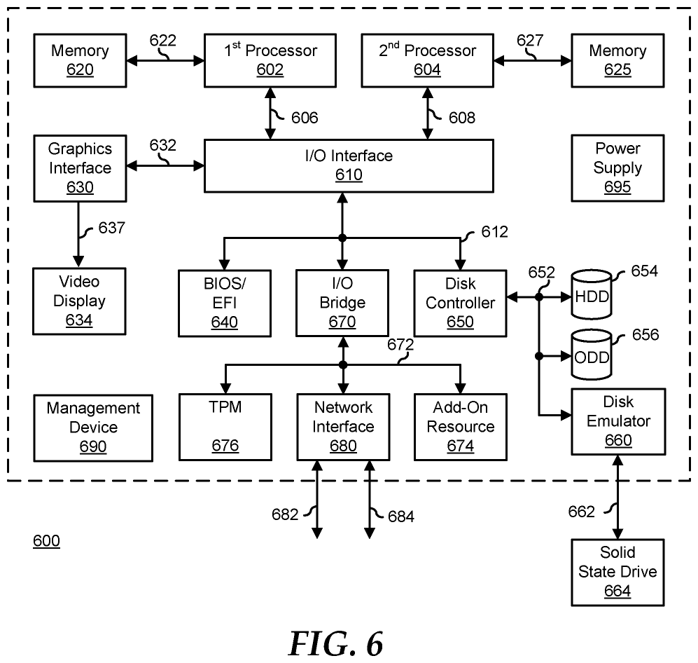

FIG. 6 illustrates a generalized embodiment of an information handling system 600 similar to information handling system 600. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below, and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656, a disk emulator 660 connected to an external solid state drive (SSD) 662, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 662, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632, and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 1394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612, or can be a different type of interface. As such, I/O bridge 670 extends the capacity of I/O channel 612 where peripheral interface 672 and the I/O channel are of the same type, and the I/O bridge translates information from a format suitable to the I/O channel to a format suitable to the peripheral channel 672 where they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600. Management device 690 can operate off of a separate power plane from the components of the host environment so that the management device receives power to manage information handling system 600 where the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory device to store code; and
a processor configured to execute code to:
define a first grouping of inputs to a first inference model;
determine a first number of inference stages for the first inference model;
calculate an accuracy of an output of the first inference model;
compare the accuracy with a threshold accuracy; and
when the accuracy is within the threshold accuracy, load the first inference model to a plurality of computing devices.

2. The information handling system of claim 1, wherein, when the accuracy is not within the threshold accuracy the processor is further configured to:
define a second grouping of the inputs to a second inference model;
determine a second number of inference stages for the second inference model;
calculate the accuracy of an output of the second inference model;
compare the accuracy with the threshold accuracy; and
when the accuracy is within the threshold accuracy, load the second inference model to the plurality of computing devices.

3. The information handling system of claim 1, wherein in defining the first grouping, the processor is further configured to determine that the inputs in each of a sub-group of the first grouping are related inputs.

4. The information handling system of claim 3, wherein the related inputs include at least one of related application variable inputs, related hardware parameter inputs, and power range inputs.

5. The information handling system of claim 1, wherein in defining the first grouping, the processor is further configured to apply at least one of a Bayesian analysis, a conditional analysis, an absolute probability analysis, and a contingency grouping analysis to the inputs.

6. The information handling system of claim 1, wherein determining the first number of inference stages is based on the first grouping.

7. The information handling system of claim 1, wherein the first number of inference stages is at least two inference stages.

8. The information handling system of claim 1, wherein the first number of inference stages is not more than three inference stages.

9. The information handling system of claim 1, wherein each of the first number of inference stages applies an artificial intelligence/machine learning (AI/ML) model.

10. The information handling system of claim 8, wherein the AI/ML model includes at least one of a regression model, a decision tree model, a support vector means model, a Naïve Bayes model, a K-nearest neighbors model, a K-means model, a random forest model, a dimensional reduction model, and a gradient boosting model.

11. A method, comprising:
defining, by a processor, a first grouping of inputs to a first inference model;
determining a first number of inference stages for the first inference model;
calculating an accuracy of an output of the first inference model;
comparing the accuracy with a threshold accuracy; and
when the accuracy is within the threshold accuracy, loading the first inference model to a plurality of computing devices.

12. The method of claim 11, wherein, when the accuracy is not within the threshold accuracy the method further comprises:
defining a second grouping of the inputs to a second inference model;
determining a second number of inference stages for the second inference model;
calculating the accuracy of an output of the second inference model;
comparing the accuracy with the threshold accuracy; and
when the accuracy is within the threshold accuracy, loading the second inference model to the plurality of computing devices.

13. The method of claim 11, wherein in defining the first grouping, the method further comprises determining that the inputs in each of a sub-group of the first grouping are related inputs.

14. The method of claim 13, wherein the related inputs include at least one of related application variable inputs, related hardware parameter inputs, and power range inputs.

15. The method of claim 11, wherein in defining the first grouping, the method further comprises applying at least one of a Bayesian analysis, a conditional analysis, an absolute probability analysis, and a contingency grouping analysis to the inputs.

16. The method of claim 11, wherein determining the first number of inference stages is based on the first grouping.

17. The method of claim 11, wherein the first number of inference stages is at least two inference stages.

18. The method of claim 11, wherein the first number of inference stages is not more than three inference stages.

19. The method of claim 11, wherein each of the first number of inference stages applies an artificial intelligence/machine learning (AI/ML) model, including at least one of a regression model, a decision tree model, a support vector means model, a Naïve Bayes model, a K-nearest neighbors model, a K-means model, a random forest model, a dimensional reduction model, and a gradient boosting model.

20. An information handling system, comprising:
a memory device to store code; and
a processor configured to execute code to:
define a grouping of related inputs to an inference model, wherein the related inputs include at least one of related application variable inputs, related hardware parameter inputs, and power range inputs;
determine a number of inference stages for the inference model based on the grouping of inputs;
calculate an accuracy of an output of the inference model;
compare the accuracy with a threshold accuracy; and
when the accuracy is within the threshold accuracy, load the inference model to a plurality of computing devices.
